(19) United States
(12) Patent Application Publication
(10) Pub. No.: US 2008/0088703 A1
(43) Pub. Date: Apr. 17, 2008

(54) System, method and apparatus for automatically tracking and recording objects

(76) Inventor: Keith Dollahite, Tyler, TX (US)

Correspondence Address: MAIER & MAIER, PLLC, 1000 DUKE STREET, ALEXANDRIA, VA, 22314, US

(21) Appl. No.: 11/905,898

(22) Filed: Oct. 5, 2007

Related U.S. Application Data
(60) Provisional application No. 60/851,993, filed on Oct. 17, 2006.

(51) Int. Cl. H04N 5/225

(52) U.S. Cl. 348/169

(57) ABSTRACT

In accordance with at least one exemplary embodiment, a method, system and apparatus for automatically tracking and recording an object are disclosed. The moving image capture method, system and apparatus can have a video camera coupled with one or more electronically-controlled aiming mechanisms. A wireless signal transmitter can be associated with an object. A wireless signal receiver can be connected to the aiming mechanism. The wireless signal receiver can decode a data signal transmitted from the transmitter and can process data to approximate a location for a wireless signal transmitter. The wireless signal receiver can electronically control the aiming mechanism so as to capture moving images of the object in frame. Also, the video camera can be supported by a mounting structure such as a tripod mounting structure.

### CROSS REFERENCE TO RELATED APPLICATIONS

This application claims priority, under 35 U.S.C. § 119(e), to U.S. Provisional Patent Application Ser. No. 60/851,993, filed Oct. 17, 2006, the disclosure of which is incorporated by reference herein in its entirety.

### BACKGROUND

A variety of conventional video cameras (including professional video cameras, camcorders, webcams, etc.), whether analog or digital, require a user to tend to the camera in order to track and keep objects in frame that would otherwise exit from the area about the camera's line of sight. Requiring an operator to aim the video camera is often not preferred in numerous situations. For example, a spectator of an event can use a video camera to record aspects of the event, but may prefer to watch the event without the need to operate a video camera. Alternatively, conventional video cameras can be conventionally mounted (or otherwise supported) so as to record objects in frame. Unfortunately, mounted, conventional video cameras cannot track objects that head out of frame without an operator.

A variety of wireless communication modes allow for the transmission of data between various electronic devices. For example, technologies making use of wireless communication modes include Radio Frequency Identification (RFID), Bluetooth and local area network (LAN) wireless networking (commonly referred to as “WiFi”). Current and widely-used WiFi and Bluetooth technologies rely on the IEEE 802.11 wireless LAN and IEEE 802.15.1 wireless personal area network (PAN) standards, respectively, as developed by the Institute of Electrical and Electronics Engineers (IEEE). Ultra wide band (UWB) wireless networking is another wireless technology(ies) that is capable of accommodating much higher data rates that many other wireless technologies and standards. Moreover, other wireless communication modes and standards are currently on the market, or are in development and are expected to be implemented in the near future. For example, the WiMax standard (IEEE 802.16) provides greater area wireless broadband networks.

RFID is a wireless identification method that relies on storing and retrieving data from transponders (commonly referred to as “RFID tags”). Typical RFID tags include a microprocessor functionally connected to an antenna. The microprocessor stores and processes data that predictably includes unique data for identifying a specific object associated with the RFID tag. Such objects may include products, animals and persons having an RFID tag attached (removably or irremovably) thereto.

An RFID reader is used to read the data transmitted by the RFID tag. The reader decodes data that is encoded in the RFID tag's integrated circuit and transmitted to the reader from the tag's antenna using a predefined radio frequency. Importantly, such data does not have to be within the line of sight of the reader. Once decoded, the data can be transmitted to a computing device. Application software provides instructions for processing the data stored on the computing device and may perform various functions including filtering and manipulating functions.

The Bluetooth (IEEE 802.15.1) standard is one main standard for wireless networking, particularly ad hoc networking. The capability to network wirelessly is built into a Bluetooth chip, which is installed into a device. It has been found to be an efficient way for multiple devices to communicate wirelessly without the need to transmit data through a central device such as a server or a network access point.

WiFi networks are well-suited for working as both local area networks and ad hoc networks. Devices equipped with WiFi capability can communicate with wireless access points, which connect devices to a network.

UWB networks accommodate higher data rates as compared to many other wireless technologies, but tend to be short range due to the short duration of UWB pulses. On the other hand, data rates can be readily traded for range by scaling the number of pulses per data bit. As a few examples, high data rate UWB may enable wireless monitors, digital data transfer from camcorders, wireless printing of digital pictures from a camera without the need for an intervening personal computer, and the transfer of files among cell phone handsets and other handheld devices like personal digital audio and video players.

Notably, the differing wireless technologies serve their respective and often overlapping purposes. As such, making use of two or more wireless technologies in combination for a variety of purposes is possible.

### SUMMARY

According to at least one embodiment, a method of capturing moving images of an object can include transmitting a plurality of data signals from a transmitter associated with the object to a receiver. The receiver can decode the plurality of data signals. The method can also include processing data from the plurality of data signals and approximating a location for the transmitter. The method can also include aiming a camera, thereby capturing moving images of the object.

In another exemplary embodiment, a system for electronically-controlled image capture of an object can have one or more aiming mechanisms. A video camera can be operatively coupled to the one or more aiming mechanisms. A computing device can be operatively connected to the one or more aiming mechanisms. A wireless signal reader can be operatively connected to the computing device. A wireless signal transmitter can be configured to transmit a plurality of signals encoding, at least in part, identifying data to the wireless signal reader.

In yet another exemplary embodiment, a system for moving image capture is disclosed that can include a means for wirelessly transmitting a data signal from an object, a means for receiving the data signal and a means for electronically aiming a video camera at the object.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is a block diagram of an exemplary system and method for automatically capturing moving images of an object,

FIG. 2 is a schematic showing an exemplary apparatus for automatically capturing moving images of an object.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

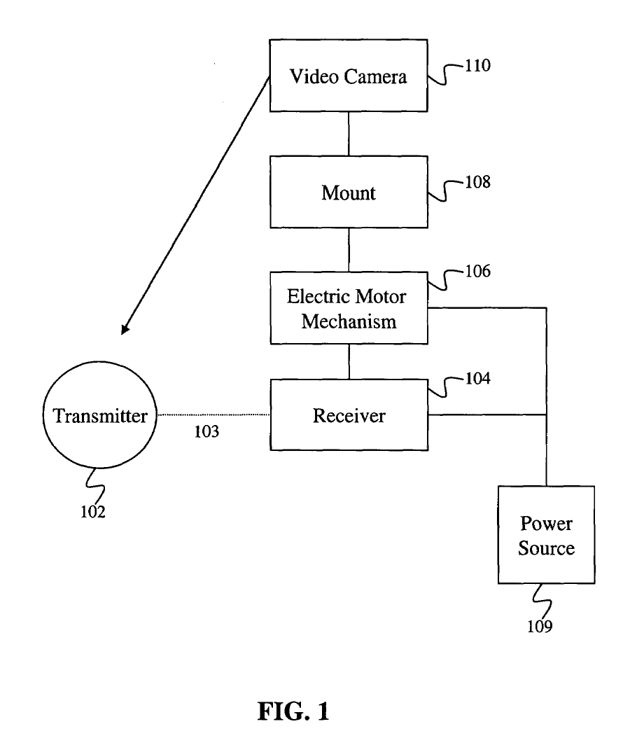

FIG. 1 illustrates a system, method and apparatus for automatically tracking an object in frame with a video camera in accordance with at least one exemplary embodiment of the present invention. Video camera 110 can be any video camera, whether analog or digital, including professional television/film video cameras, camcorders, webcams, pan-tilt-zoom (PTZ) cameras, closed-circuit television cameras, digital cameras having video capabilities and the like known to one having ordinary skill in the art. Additionally, video camera 110 can capture moving images that can be embodied on mediums such as film, videocassette, digital mediums (e.g., magnetic storage mediums, optical disk, solid-state memory cards, etc.) and like mediums known to one having ordinary skill in the art. Moreover, video camera 110 can capture moving images and a feed can be established to display those images in real-time on a display such as a television screen or a monitor.

Also, as is known in the art, video camera 110 can have zoom functionality for bringing objects into closeup or, alternatively, for receding objects into longshot while maintaining focus. Video camera 110 can have auto-focus capability as another exemplary feature. In at least one exemplary embodiment, zoom functionality and/or auto-focus capability can be electronically controlled. Moreover, various other well-known video camera features are present in commercially available models that do not bear repeating here, which can also be subject to electronic control in at least one exemplary embodiment.

For instance, video camera 110 may be a digital or analog camcorder if, for example, compact design and significant video storage is desired because typical camcorders have a camera and a storage medium (e.g., videocassette, magnetic storage device, optical disk, solid-state memory cards, etc.) in a self-contained unit. Numerous suitable video camcorders are commercially available as will be appreciated by one having ordinary skill in the art.

Still referring to FIG. 1, video camera 110 can be operatively coupled to one or more aiming mechanisms. Exemplary aiming mechanisms can consist of both mount 108 (or portion/components thereof) and one or more motor mechanisms 106, which can be electric motor mechanisms. Mount 108 can also support and/or steady the video camera for obtaining smoother and clearer moving image capture. In at least one exemplary embodiment, mount 108 can be a tripod mounting structure and like mounting structures known to one having ordinary skill in the art.

Electric motor mechanism 106 can provide aiming functionality by moving portions of mount 108 and/or video camera 110. Video camera 110 can be directly supported by mount 108 or directly coupled to electric motor mechanism 106 or both. For example, video camera 110 can be directly supported by mount 108 and indirectly aimed, at least in part, by electric motor mechanism 106 controlling a portion of mount 108. Alternatively, video camera 110 can be directly connected to a mounting portion of electric motor mechanism 108. Electric motor mechanism 108 can also be operatively coupled to mount 108. Further, video camera 110 can be conjunctively coupled to mount 108 and electric motor mechanism 106, for example, by making use of different portions of video camera 110 for attachment to each.

As previously stated, mount 108 can be a tripod mounting structure having a mounting portion for coupling video camera 110 and/or electric motor mechanism 106 thereto and like independent mounts known to one having ordinary skill in the art. Alternatively, mount 108 can have a mounting portion for coupling video camera 110 and/or electric motor mechanism thereto where mount 108 can also be adapted for attachment to a secondary structure(s). Mount 108 may be dependent on the secondary structure in order to provide stability to video camera 110 and the resulting moving image capture thereof. For example, mount 108 can have a portion for stably attaching mount 108 to a fixed structure.

Electric motor mechanism 106, optionally, in conjunction with a component of mount 108 can provide an automatic ball-and-socket mechanism, an automatic planar rotational mechanism and the like known to one having ordinary skill in the art. For example, a ball-and-socket mechanism operatively coupled to video camera 110 can pan video camera 110 right-of-center and left-of-center in the horizontal, and, singularly and conjunctively, above-center and below-center in the vertical to capture moving images within the video frame in likewise directions. Also, whether in the horizontal or vertical and any axis there between, video camera 110 can be rotated up to a full 360 degrees, although significantly less rotational freedom is contemplated in some exemplary embodiments.

As another non-limiting example, a planar rotational mechanism controlled by electric motor 106 is contemplated for use with at least one exemplary embodiment. A planar rotational mechanism can pan video camera 110 right-of-center and left-of-center substantially along a horizontal direction up to a full 360 degrees. Other automatic, electrically-controlled aiming mechanisms will be appreciated by one having ordinary skill in the art. For example, mount 108 can also have telescoping functionality and like elevator functionality responsive to electric motor mechanism 106 for moving video camera 110 above-center and below-center in the vertical.

Still referring to FIG. 1, electric motor mechanism 106 can be operatively connected to receiver 104. In at least one exemplary embodiment, receiver 104 can also be operatively connected to video camera 110. Receiver 104 can include a computing device for storing and processing data. The computing device can store and process data for controlling the one or more electric motor mechanisms 108 so as to directionally control the movement of video camera 110. Also, the computing device can directly control features of video camera 110 such as zooming functionality. As such, electric motor mechanism 108 and/or video camera 110 can be considered to be in a peripheral relationship with the computing device. Nevertheless, zooming functionality and other features can alternatively be controlled by the electronics of video camera 110 as will be appreciated by one having ordinary skill in the art.

Receiver 104 can also include a wireless signal reader for decoding wireless data signals and transmitting the data to a computing device for processing. As previously stated, a computing device can be a component of receiver 104. Alternatively, the computing device may be external of receiver 104. Further, a wireless signal reader and a computing device can be integral.

Data signals 103 can be transmitted to a wireless signal reader of receiver 104 by wireless signal transmitter 102 directly or indirectly (e.g., with or without using network access points and/or servers), for example, via a predefined radio frequency. Moreover, wireless communications modes can include Radio Frequency Identification, Bluetooth, WiFi, UWB systems and any combination thereof, and the like known to one having ordinary skill in the art. For example, transmitter 102 can be an RFID tag and receiver 104 can be (or can include as a component thereof) a RFID reader. Exemplary RFID tag and reader systems can be selected based on desired ranges. Also, both passive and active RFID tags are contemplated by embodiments of the present invention.

Wireless signal transmitter 102 can be affixed or otherwise associated with objects including inanimate objects such as a piece of sporting equipment (e.g., playing ball) and animate objects such as a person. For example, a wireless signal transmitter 102 can be incorporated into or placed on various articles a person wears or removablely attaches to themselves, their clothing and the like. Moreover, persons such as athletic competitors can have an RFID tag associated with them in various ways during sporting events and practice exercises as will be appreciated by one having skill in the art.

Wireless transmitter 102 and a wireless reader of receiver 104 can transmit data signal 103 within a predefined or definable area. The predefined or definable area may be such that the area includes the entire usable range where transmitter 102 is capable of transmitting data signal 103 to receiver 104. Alternatively, singularly or in conjunction, the predefined or definable area may be such that it includes the entire range of motion and distance that video camera 110 is capable of capturing moving images of. Moreover, the predefined or definable area can encompass an area bounded by any other means known to one having ordinary skill in the art.

Data signal 103 can be a unique, continuous data signal. For example, a plurality of data signals can be transmitted from a RFID tag and decoded by a RFID reader. Each data signal can encode, inter alia, a unique identifier such as a unique identification number. A plurality of data signals 103 can be transmitted from a RFID tag to a RFID reader such that any intermittence is negligible in function. Thus, the plurality of data signals 103 function as a substantially continuous data signal or stream. Since each data signal can encode a unique identifier, the substantially continuous data stream can consist, at least in part, of repeated unique identifiers.

Still referring to FIG. 1, receiver 104 can have a pairing feature, which can serve to configure transmitter 102 with receiver 104. A button or other selectable item can be placed on receiver 104 to allow a user to activate pairing functionality. During the pairing process or shortly before initiating the pairing process, transmitter 102 can be placed at one or more predetermined positions in relation to receiver 104, such as one or more predetermined positions directly in front of receiver 104. One or more data signals 103 can be transmitted to receiver 104 for configuring the transmitter 102 and the default location thereof.

After the initial pairing process, each time data signals 103 are received from transmitter 102 by receiver 104, a computing device of (or coupled to) receiver 104 can process data embodied in data signals 103, which can be use to map the location of transmitter 102 against its default location configured during the pairing process. The computing device of (or coupled to) receiver 104 can process data signals 103 to approximate within a suitable degree of accuracy the location of transmitter 102 and, thus, an object associated therewith.

In turn, the computing device can control electronic motor mechanism 106 so as to aim video camera 110 at the object associated with transmitter 102 including panning and telescoping (or otherwise raising and lowering) video camera 110 as a couple non-limiting examples. Also, the computing device can directly control features of video camera 110 such as zooming functionality for capturing moving images of the object associated with transmitter 102. Aiming can be continuously performed so as to track the object associated with transmitter 102 in frame.

An exemplary computing device can approximate location by not only processing the data directly encoded by data signals 103, but can also output and further process metadata derived from data signals 103. For example, metadata can be outputted and processed that relates to relationships including temporal and spatial relationships between each data signal 103 transmitted.

For illustrative purposes and in a non-limiting manner, if transmitter 102 is associated with an athletic competitor, then video camera 110 can track the competitor in frame during a sporting event or practice exercise. Because video camera 110 can track transmitter 102 and may record activities of an athletic competitor in frame, a resulting video recording can have enhanced value as a training and game strategy tool.

As shown, one or more power sources 109 can be connected to receiver 104 and/or electric motor mechanism 106 for powering and/or charging each. Additionally, one or more power sources 109 can be connected to video camera 110 for powering and/or charging the same. Power source 109 can be a battery, AC power and the like known to one having ordinary skill in the art. Transmitter 102 may have a separate power source and may be an active RFID tag. Moreover, transmitter 102 can use other known wireless communication modes and can have a suitable power source as will be appreciated by one having ordinary skill in the art.

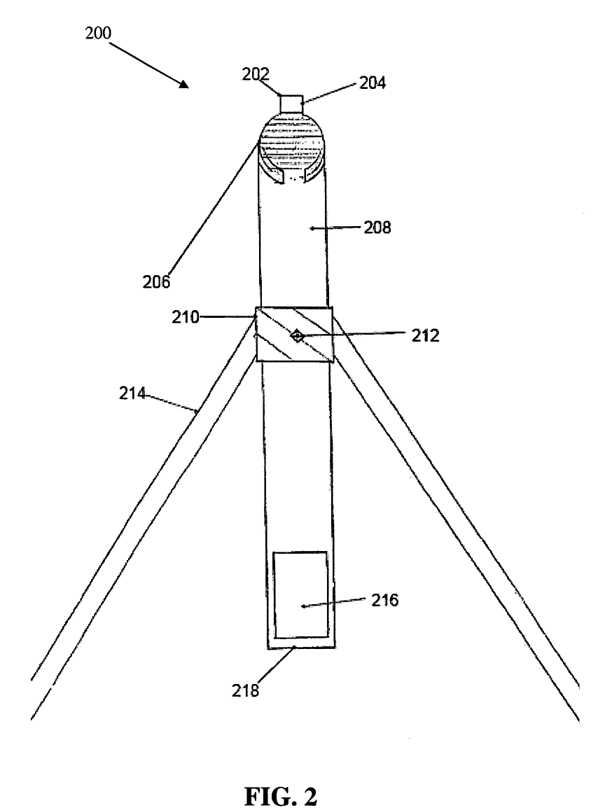

Now referring to FIG. 2, in at least one exemplary embodiment, an independent mounting and control system 200 such as a tripod mounting and control system can include a variety of components for tracking and recording an object with a video camera in frame. For example, mounting system 200 can have a video camera mounted and connected thereto and can be suitably positioned so as to automatically track and record a person associated with a wireless signal transmitter during an activity or event such as a recreational activity or sporting event. Moreover, by attaching a transmitter, a person can record self-performed activities such as sports-related practice exercises for later analysis as a learning tool. Also, a camera-equipped mounting system 200 can automatically track and record an object such as a playing ball associated with a wireless signal transmitter so as to capture aspects of the entire sporting event as another non-limiting example.

Such exemplary uses do not require a person to manually track and record activities freeing that person to, for example, watch a sporting event, or participate in a sporting event or practice exercise. Other uses are contemplated and will be readily appreciated by one having ordinary skill in the art.

Still referring to FIG. 2, mounting system 200 can include a universal connection 202 for electronically interfacing a video camera (not shown) such as a camcorder to system 200. Universal connection 202 can be or include conventional screw and threaded-receiver connections, circuit board interfaces, pin-socket connections, serial bus connections and like connections for connecting a suitable video camera known to one having ordinary skill in the art. Also, a power source can be connected to universal connection 202 for powering a video camera.

Mounting system 200 can also incorporate wireless signal receiver/sensor 204 proximate to or integral with universal connection 202 as well as on any other portion of mounting system 200. As previously discussed in reference to FIG. 1, wireless signal receiver/sensor 204 can include a reader and computing device for decoding a data signal and processing the data in order to aim a video camera at a location within a predefined or definable area.

The data signal can be encoded and transmitted by a wireless signal transmitter associated with an object and the data transmitted can provide the basis for approximating a location for the object. For example, wireless communications modes can include Radio Frequency Identification, Bluetooth, WiFi, UWB systems and any combination thereof, and the like known to one having ordinary skill in the art. For instance, the transmitter can be an RFID tag and receiver 204 can be (or can include as a component thereof) a RFID reader.

In at least one exemplary embodiment, mounting system 200 can include ball-and-socket aiming mechanism 206 that can be motorized (e.g., electrically) and can have a mounting portion for a video camera. A video camera can be coupled to ball-and-socket mechanism 206, for example, by securing the video camera to a portion thereof. Also, ball-and-socket mechanism can be operatively connected to receiver 204 so as to receive instructions from receiver 204 (e.g., a computing device thereof) and move video camera in response so as aim the video camera at a transmitter and the object associated therewith. Ball-and-socket mechanism 206 can pan a video camera in both the horizontal and vertical as directed by receiver 204. Ball-and-socket mechanism 206 may also be capable of being operated manually in order to manually aim a video camera.

Alternatively, singularly or in conjunction, mounting system 200 can include another aiming mechanism such as telescoping tubular member 208. Telescoping tube 208 can house one or more motors (e.g., electric motors) for raising and lowering telescoping tube 208, which can, in turn, vary the height of a video camera connected to mounting system 200. For example, varying the height of a video camera can allow it to capture moving images from different angles. Telescoping tube 208 can be connected to receiver 204 and respond to the aiming instructions provided thereby. Alternatively, singularly or in conjunction, telescoping tube 208 can house one or more other receivers that can be similar to receiver 204, which can provide instructions for aiming a video camera to telescoping tube 208. In at least one other embodiment, telescoping tube 208 can be adjusted manually.

Telescoping tube 208 can be supported by harness 210. Harness 210 can allow telescoping tube 208 to telescope and retract automatically or manually as needed. Harness 210 can have locking device 212 for locking telescoping tube 208 at a desired height. Alternatively, mounting system 200 can incorporate any other aiming mechanism for varying the height of a camera known to one having ordinary skill in the art.

Harness 210 can be connected to support legs 214 as part of a tripod mounting structure. In the exemplary tripod embodiment of FIG. 2, there can be a set of three support legs 214 (two shown) connected to harness 210. Support legs 214 may be manually adjustable for positioning mounting system 200 and a video camera mounted thereon. In at least one other exemplary embodiment, mounting system 200 can include a solid or hollow base member as alternatives to support legs 214 as will be appreciated by one having ordinary skill in the art. Other suitable support/mounting structures and apparatuses for use with exemplary embodiments are contemplated and known by those having ordinary skill in the art.

Mounting system 200 can include battery 216 that may serve a variety of purposes including powering the one or more motors in system 200. Also, battery 216 can power receiver 204 and any other receivers in system 200. Moreover, battery 216 can power a video camera connected to mounting system 200 via universal connection 202. Also, battery 216 may be placed inside the lower portion of system 200 so as to act as a counterweight to the top portion of system 200. Battery access means 218 can be included to allow a person to access battery 216 to, for example, check, change or upgrade battery 216. For example, battery access means 218 may be a door located on the bottom portion of system 200.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of capturing moving images of an object comprising:
transmitting a plurality of data signals from a transmitter associated with the object to a receiver;
decoding the plurality of data signals;
processing data from the plurality of data signals;
approximating a location for the transmitter; and
aiming a camera, thereby capturing moving images of the object.

2. The method of claim 1 wherein the plurality of data signals are transmitted at a radio frequency.

3. The method of claim 1 wherein the plurality of data signals form a substantially continuous data stream.

4. The method of claim 1 wherein the plurality of data signals repeatedly encode a unique identifier.

5. The method of claim 1 wherein the transmitter is a RFID tag and the receiver is an RFID reader.

6. The method of claim 1 wherein aiming the camera is at least one of panning and zooming.

7. The method of claim 1 wherein the object is a person.

8. The method of claim 1 wherein the data from the plurality of signals includes metadata for approximating the location.

9. The method of claim 1 further comprising:
recording moving images from the camera on a storage medium.

10. The method of claim 1 further comprising:
feeding moving images from the camera to a display.

11. A system for electronically-controlled image capture of an object comprising:
one or more aiming mechanisms;
a video camera operatively coupled to the one or more aiming mechanisms;
a computing device operatively connected to the one or more aiming mechanisms;
a wireless signal reader operatively connected to the computing device; and
a wireless signal transmitter configured to transmit a plurality of signals encoding, at least in part, identifying data to the wireless signal reader.

12. The system of claim 11 wherein the wireless signal transmitter is a RFID tag.

13. The system of claim 11 wherein the computing device and the wireless signal reader are integral.

14. The system of claim 11 wherein the one or more aiming mechanisms is at least one motorized ball-and-socket mount.

15. The system of claim 11 further comprising:
one or more power sources connected to at least one of the one or more aiming mechanisms, the video camera, the computing device and the wireless signal reader.

16. The system of claim 11 further comprising:
a mounting structure supporting the video camera.

17. The system of claim 16 wherein the mounting structure is a tripod.

18. The system of claim 16 wherein the mounting structure has a telescoping member for raising and lowering the video camera.

19. The system of claim 11 wherein the video camera is a video camcorder.

20. A system for moving image capture comprising:
a means for wirelessly transmitting a data signal from an object;
a means for receiving the data signal; and
a means for electronically aiming a video camera at the object.
